(19) United States
(12) Patent Application Publication
(10) Pub. No.: US 2010/0122283 A1
(43) Pub. Date: May 13, 2010

(54) Targeted advertising via mobile enhanced reality

(75) Inventor: Vincent E. Button, Dallas, TX (US)

Correspondence Address: ALCATEL-LUCENT, C/O GALASSO & ASSOCIATES, LP, P. O. BOX 26503, AUSTIN, TX, 78755-0503, US

(73) Assignee: Alcatel-Lucent USA Inc.

(21) Appl. No.: 12/584,090

(22) Filed: Aug. 31, 2009

Related U.S. Application Data
(60) Provisional application No. 61/198,944, filed on Nov. 12, 2008.

(51) Int. Cl. H04N 7/025; G06Q 30/00; G06F 15/16; G06F 17/30

(52) U.S. Cl. 725/32; 705/27; 709/206; 707/E17.005

(57) ABSTRACT

A method, device and system for providing product recognition services to a mobile device that permits a user to obtain enhanced images of the product and/or additional information and/or website links related to the product directly through the product recognition services is disclosed. A mobile device is utilized to capture video of a real-world product and access more information about the product using a one click video call over a high speed wireless data network from the mobile device to a picture recognition server where the real-world product can be recognized. Information, including a video, can be sent to the mobile phone about the recognized product and access to web servers for additional information about the product can be provided. A bookmarking feature allows a user to send the same information about the product to a list of friends of the user at the friends' preferred mobile phones, personal computers (PCs) or televisions (TVs).

### CROSS REFERENCE TO RELATED APPLICATIONS

This United States non-provisional patent application claims priority to U.S. provisional patent application No. 61/198,944 entitled “Targeted Advertising via Mobile Enhance Reality” filed on Nov. 12, 2008.

### FIELD OF THE DISCLOSURE

The disclosures made herein relate generally to the telecommunications industry. The invention discussed herein is in the general classification of a method, device and system for providing/acquiring product or service information to/at a mobile device.

### BACKGROUND

This section introduces aspects that may be helpful in facilitating a better understanding of the invention. Accordingly, the statements of this section are to be read in this light and are not to be understood as admissions about what is in the prior art or what is not in the prior art.

When a consumer encounters a product placement in the marketplace, he most frequently uses a search engine on his mobile device to discover more information about the product when desired. However, this is not necessarily the preferred method for the product manufacturer, distributor or advertiser to distribute information about the product.

When a potential customer comes across a product placement, it may contain the Uniform Resource Locator (URL)/address of a website related to that product. Using a mobile telephone, it is often tedious to enter the URLs via the mobile telephone's number keys or keyboard. As a result, the potential customer will often decide not to access the URL or may minimize his typing by simply entering the relevant product name from the product placement into a search engine. In the latter case, the customer will often be directed to a website that is not the same as the URL listed on the product. If the original URL on the product placement could lead to a sales opportunity, then by using a search engine, the association between the product placement and the opportunity to purchase the product from the website having that URL is lost.

For example, if a movie poster contains a URL for the movie studio where a product can be purchased, and a customer utilizes a search engine to find more information using the movie's title rather than typing this URL into the customer's mobile device, the customer will likely be directed to a different website. This creates a business opportunity for a potential competitor rather than the actual advertiser.

It is often desirable to be able to utilize product placements, newsletters and other physical media to direct easily accessible content to mobile consumers. This permits the consumers of such products to use service portals of a party creating these product placements, newsletters and other physical media rather than some third party. The integration of certain technologies permits this targeted advertising to customers and provides easy access to information and the ability to purchase an advertised product or service.

Currently, there is no method, device or system for providing product recognition services to a mobile device that permits a user to obtain enhanced images of the product and/or additional information and/or website links related to the product directly through the product recognition services.

Hence, there is a need for a convenient to use, reliable, cost-effective method, device and system for providing product recognition services to a mobile device that permits a user to obtain enhanced images of the product and/or additional information and/or website links related to the product directly through the product recognition services.

### SUMMARY OF THE DISCLOSURE

Certain embodiments of the present invention provide a method, device and system for providing product recognition services to a mobile device that permits a user to obtain enhanced images of the product and/or additional information and/or website links related to the product directly through the product recognition services.

Certain embodiments of the invention utilize the ubiquitous mobile phone camera to capture live video containing images of the product placement and permit access to more information about the product placement using a one click video call over a high speed wireless data network from the mobile phone to a picture recognition server where the real-world product can be recognized. Information, including a video, can be sent to the mobile phone with information about the recognized product and access to web servers for additional information about the product can be provided.

In certain embodiments of the invention, further bookmarking of the product to a list of friends of the mobile phone user and further product purchase opportunities to the mobile phone user and his friends from a list of friends may be made available to mobile phones, personal computers (PCs) and televisions (TVs) of a consumer and/or his friends.

Under some applications, the embodiments of the invention may provide ease of access to additional information about a product or service.

Under some applications, the embodiments of the invention may provide the first opportunity at creating a product purchase opportunity with a potential customer from a product placement for an entity associated with the product placement.

Under some applications, the embodiments of the invention may provide the ability to rapidly access information related to a real-world product using a mobile phone camera and a mobile enhanced reality product.

Under some applications, the embodiments of the invention permit distribution of information about the product to a social network of a potential customer.

Under some applications, the embodiments of the invention provide a method and a system that is relatively inexpensive to implement that provides product recognition services to a mobile device that permit a user to obtain enhanced images of the product and/or additional information and/or website links related to the product directly through the product recognition services.

Under some applications, the embodiments of the invention provide a method and system that efficiently provides product recognition services to a mobile device that permit a user to obtain enhanced images of the product and/or additional information and/or website links related to the product directly through the product recognition services.

Under some applications, the embodiments of the invention provide a method and system that reliably provides product recognition services to a mobile device that permit a user to obtain enhanced images of the product and/or additional information and/or website links related to the product directly through the product recognition services.

### BRIEF DESCRIPTION OF THE DRAWINGS

Some embodiments of apparatus and/or methods of the present invention are now described, by way of example only, and with reference to the accompanying drawings, in which:

FIG. 1 schematically illustrates the system utilized in a preferred embodiment of the present invention without bookmarking.

FIG. 2 schematically illustrates the system utilized in a preferred embodiment of the present invention with bookmarking.

FIG. 3 schematically illustrates the system utilized in a preferred embodiment of the present invention by showing the Interactive Media Manager (IMM) and Mobile Enhanced Reality (MER) Architecture and Protocols.

FIG. 4A schematically illustrates the IMM-MER Architecture call flow in a preferred embodiment of the present invention.

FIG. 4B further schematically illustrates the IMM-MER Architecture call flow in a preferred embodiment of the present invention.

FIG. 4C further schematically illustrates the IMM-MER Architecture call flow in a preferred embodiment of the present invention.

FIG. 5 depicts the method of a preferred embodiment for obtaining more information related to a product placement at a mobile client and transmitting a bookmark to a bookmark server from the mobile client.

FIG. 6 depicts the method of a preferred embodiment for providing information related to a product placement from a recognition server to a mobile client.

FIG. 7 depicts the method of a preferred embodiment for providing more information related to a product placement to a list of buddies associated with a mobile client or to a mobile client's preferred device.

FIG. 8 depicts the database design of the bookmark server of a preferred embodiment of the invention.

### DETAILED DESCRIPTION OF THE DRAWINGS

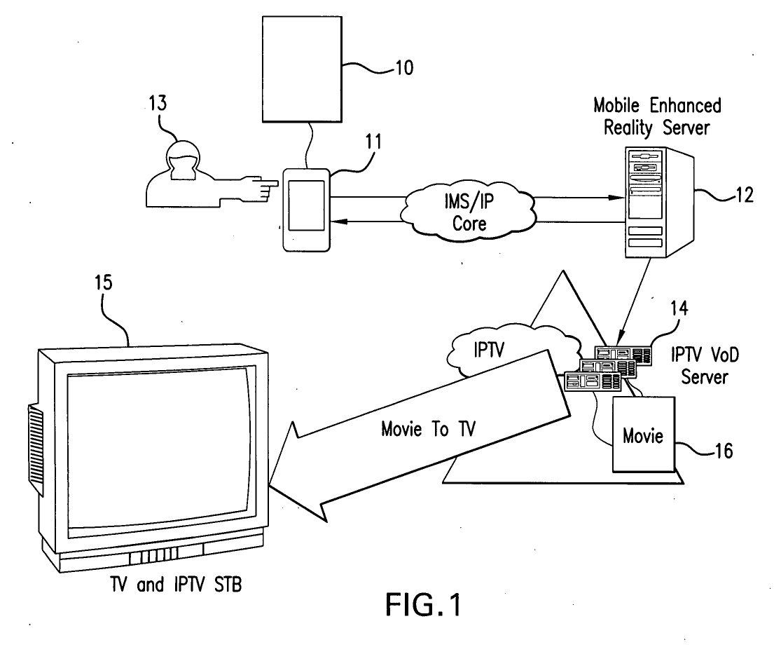

FIG. 1 schematically illustrates the system utilized in a preferred embodiment of the present invention without bookmarking. Using the mobile camera on a mobile device (mobile client), a real-world product can be recognized using picture recognition (e.g. recognizing a movie poster or Digital Video Disc (DVD) case), pattern recognition (e.g. recognizing a barcode or quick-read code (QRCode)), or text recognition (e.g. optical character recognition of the website URL). This recognition is performed using the mobile enhanced reality product. Once a product is recognized, the mobile device can immediately take the customer to a content site associated with that product where more information can be retrieved and the product can be purchased.

Because the customer is provided instant recognition of the product, he is not required to enter a search term or type a lengthy URL address into a mobile device. He will only be directed to the appropriate server to receive more information about the product and purchase the product.

In this example, the mobile phone customer has an integrated television, internet and mobile phone plan from the customer's service provider. Typically, a parent will not permit his children to rent movies on the television Video on Demand (VOD) service. When a customer/parent 13 is on a business trip, he encounters a poster/product 10 for a movie that he believes may appeal to his children. The poster/product 10 is tagged with an identifier that indicates that it can be recognized through use of a mobile phone camera and mobile enhanced reality server 12. The customer parent 13 clicks a button on the mobile device 11 to begin the recognition process. Alternatively, the user could begin the recognition process by starting the recognition application from the application folder of the mobile device. The live video containing images is continuously streamed to the mobile enhanced reality server 12, and the camera of the mobile device 11 can be adjusted until the mobile enhanced reality server 12 recognizes an image in the video stream. Upon recognition of the poster/product 10, the mobile device 11 menu now provides options to get more information about the poster/product 10. The parent/customer 13 then selects to receive more information on the menu of the customer mobile device 11.

The mobile device web browser can be activated to navigate to a product website where the parent/customer 13 can learn about the movie and watch a preview. The parent/customer 13 is also given the option to purchase the movie. After reviewing the movie, the parent/customer 13 can determine if it is suitable for viewing by his children and purchase the asset/advertised product as a VOD rental for his home television service. Once the video is purchased, a notification arrives at the household TV 15 of the parent/customer 13 announcing that the movie 16 advertised in poster/product 10 has been purchased from the IPTV VOD server 14 and is available for viewing.

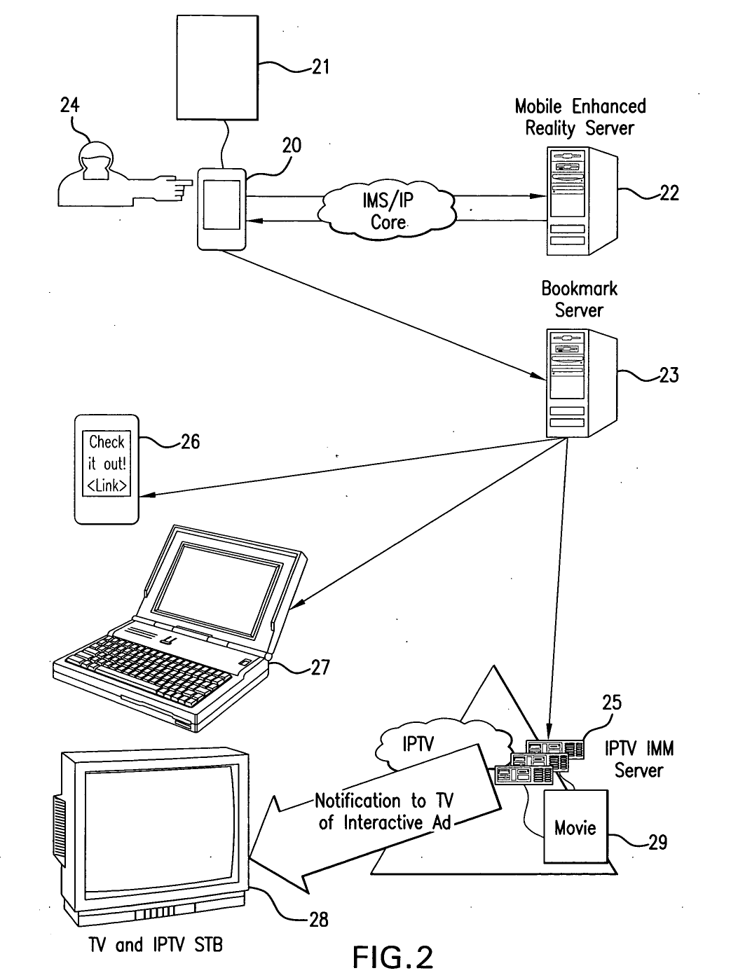

FIG. 2 schematically illustrates the system utilized in a preferred embodiment of the present invention with bookmarking.

A customer 24 uses a mobile device 20 to recognize a product/poster 21 advertising a movie through the use of a Mobile Enhanced Reality (MER) Server 22. The customer 24 bookmarks the product/poster 21 in the bookmark server 23. Bookmark notifications are sent to each of the customer's buddies from a customer buddy list stored at the bookmark server 23. Each buddy can access information about the product/poster 21 from the IMM servers 25. The IMM servers 25 are a content management system that provides additional content on the product/poster 21 to end devices (i.e. mobile telephone 26, computer 27 and television 28).

Once a product is recognized, the mobile customer 24 can bookmark the product/poster 21 by sending a bookmark with an optional message to the bookmark server 23 which stores an association between the product/poster 21 and the mobile customer 24. The bookmark server contains a list of friends/contacts (buddy list) of the mobile customer. For each buddy, a notification regarding the product is sent to that buddy's preferred device (e.g. mobile telephone 26, computer 27, television 28).

Each buddy and mobile customer can access the same information about the product from their own preferred device. Each customer can learn more about the product from the appropriate websites and be given an opportunity to purchase the advertised product.

The bookmark notification is sent to the customer's device of choice via a short message service (SMS or text message), e-mail or other alternative and to the buddies on the customer's buddy list to permit each contact of a customer to review the movie 29 and purchase the movie 29 from the same product agency if desired.

In all instances, the service used to purchase the asset is associated with the poster on display which makes it more likely that if the asset is purchased, it will be done from the preferred website rather than a third party's website.

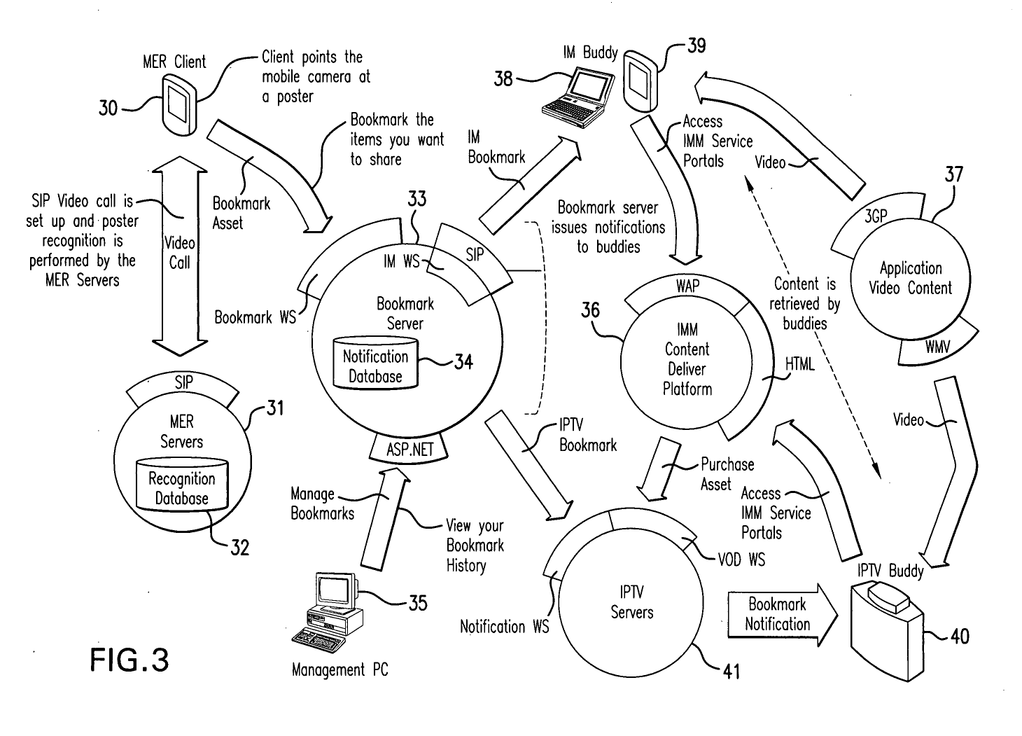

FIG. 3 schematically illustrates the system utilized in a preferred embodiment of the present invention by showing the IMM and MER Architecture and Protocols.

In this diagram, a video call (via a Session Initiation Protocol (SIP) video call over a high speed wireless data network in this preferred embodiment) is set up between the MER client 30 (mobile device) and the MER server 31 (recognition server) when a mobile customer comes across a product placement and desires more information about the product. More information about the product is sent to the MER client 30 if information about the product is contained in the recognition database 32 of the MER server 31. The video displayed on the MER client 30 often shows the real-world product but enhances the image with additional information such as a video, text or audio overlay sent from the MER server 31. This encourages the customer to want to learn more and often he/she bookmarks the product by pressing a button on the MER client 30.

The bookmark is sent to the bookmark server 33 where notifications of the product are sent to each of the customer's buddies via their preferred notification device (e.g. computer 38, mobile device 39 or television 40). The list of buddies for the customer is contained in a notification database 34 at the bookmark server 33. The bookmarking history of a customer can be viewed and the list of buddies for a customer can be managed and updated through the use of a management PC 35 or other means.

Each buddy and the original customer can access more information about the product from the IMM content delivery platform 36 and application video content servers 37. This content is easily created for each product using an appropriate IMM application. IMM lets a provider create similar content for mobile phone, computer and television users in a very efficient and standardized manner. After reviewing the content for the product, any one of the consumers (original or buddies) may immediately purchase it from the preferred supplier. For example, the buddy utilizing a TV 40 as a preferred notification device may purchase a movie to be sent via the IPTV servers 41.

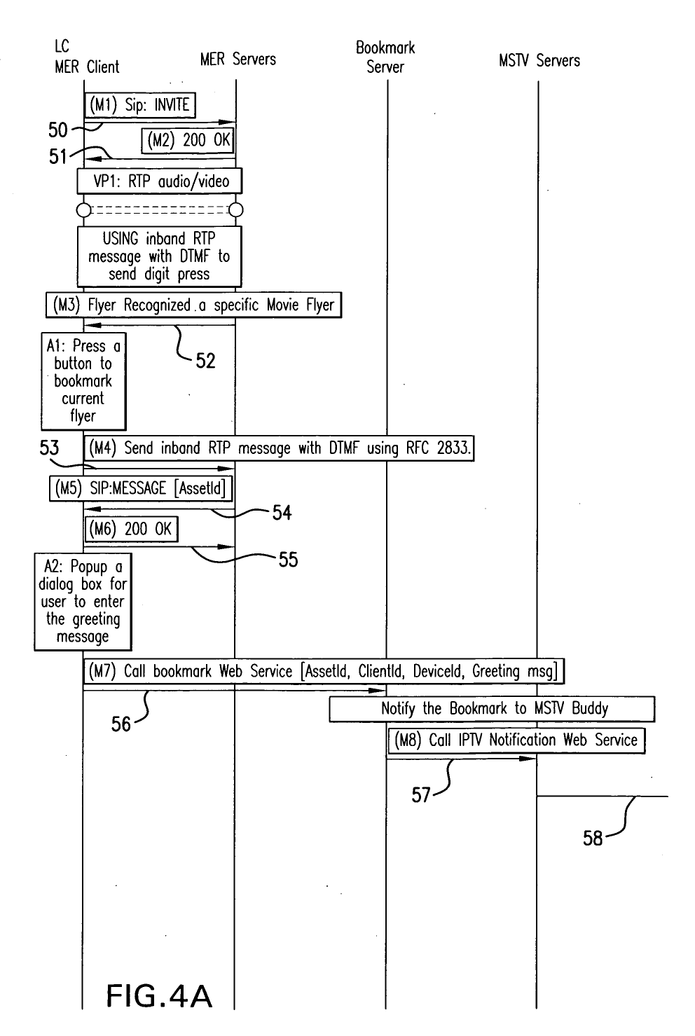

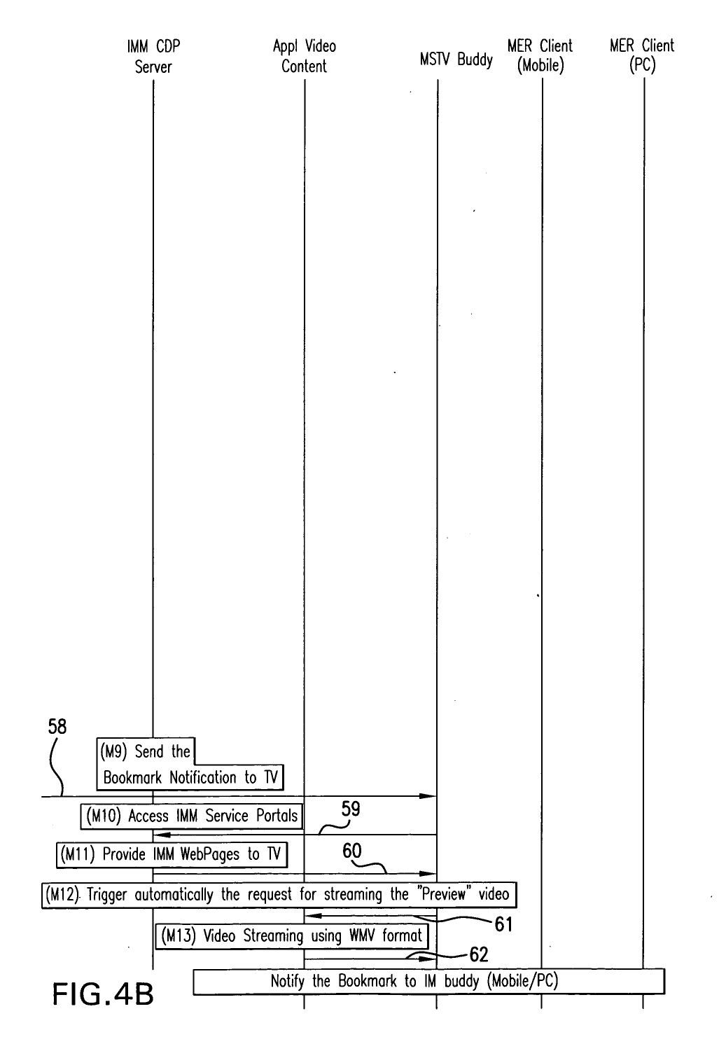

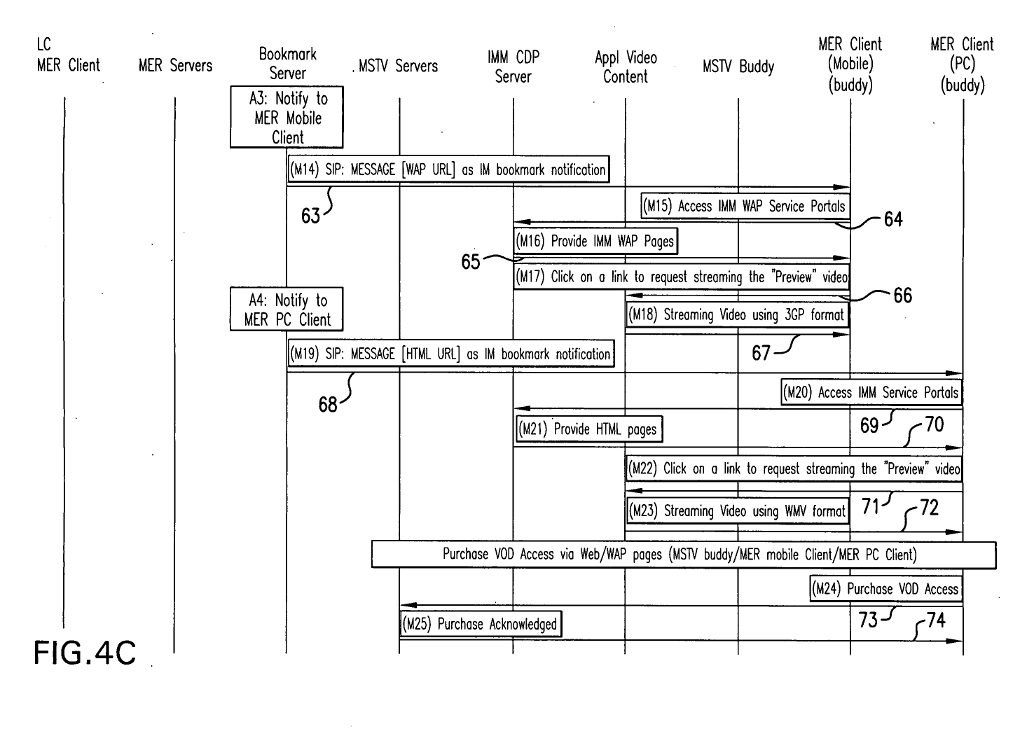

FIG. 4A schematically illustrates the IMM-MER Architecture call flow in a preferred embodiment of the present invention. A SIP invite message 50 is sent from the MER client to the MER servers when an appropriate button on the MER client is pressed whenever recognition of a product placement (i.e. movie flyer) is desired on the MER client. A SIP response message 51 is then sent from the MER Servers to the MER client. The MER servers return a message 52 to the MER client, indicating that the product placement has been recognized by the MER servers.

A user can then press a button at the MER client to bookmark the movie flyer. The MER client sends an inband Real-Time Transport Protocol (RTP) message 53 with Dual-Time Multi-Frequency (DTMF) using Request for Comments (RFC) 2833 to the MER servers. The MER servers send a SIP message 54 identifying the product to the MER client and the MER client sends a SIP response message 55 to the MER servers acknowledging receipt of the SIP message 54.

A popup dialog box for the MER client to use allows him to enter a greeting message. A software procedural call 56 is then placed between the MER client and the bookmark server. This permits the bookmark server to notify a MSTV (Microsoft, Mediaroom) buddy of the MER client of the product. MSTV is one example of an IPTV middleware platform. The notification is done by the bookmark server placing a call 57 to the MSTV server.

As shown in FIGS. 4A-4B, the bookmark notification 58 is then sent to the MSTV buddy from the MSTV server. As shown in FIG. 4B, the MSTV buddy then accesses the IMM content delivery platform server 59. The IMM content delivery platform then provides the appropriate IMM web pages to the MSTV buddy 60. The MSTV buddy then triggers the request 61 for streaming of the preview video associated with the movie flyer to the application video content server. The application video content server then sends the video using Windows Media Video (WMV) format to the MSTV buddy 62.

FIG. 4C further schematically further illustrates the IMM-MER Architecture call flow in a preferred embodiment of the present invention. The bookmark server also notifies the mobile buddy of the MER client of the product. The bookmark server sends a SIP message 63 as a bookmark notification to the mobile buddy. The mobile buddy then accesses the IMM content delivery platform server 64. The IMM content delivery platform server sends the IMM Wireless Application Protocol (WAP) web pages to the mobile buddy 65. By clicking on a link, the mobile buddy can access the application video content server to obtain streaming of the preview video associated with the movie flyer 66. The application video content server streams the video to the mobile buddy using the 3GP format 67.

In addition, the bookmark server notifies the PC buddy of the MER client of the product. The bookmark server sends a SIP message as a bookmark notification to the PC buddy 68. The PC buddy accesses the IMM content delivery platform server 69. The IMM content delivery platform server provides the Hyper Text Markup Language (HTML) pages to the PC buddy 70. By clicking on a link to request streaming of the preview video, the PC buddy accesses the application video content server 71. The application video content server then streams the video in WMV format to the PC buddy 72. The PC buddy can then contact the MSTV servers to purchase the VOD access 73 and the purchase acknowledgement can be sent from the MSTV servers to the PC buddy 74.

In alternative embodiments, the same methodology could be used to send the information and video to the mobile client's preferred device such as a set-top box, PC or mobile device as used to send the information and video to the MSTV buddy, PC buddy and mobile buddy. In addition, the MSTV buddy and mobile buddy could also purchase VOD from the MSTV server in a similar manner as that described in conjunction with the PC buddy.

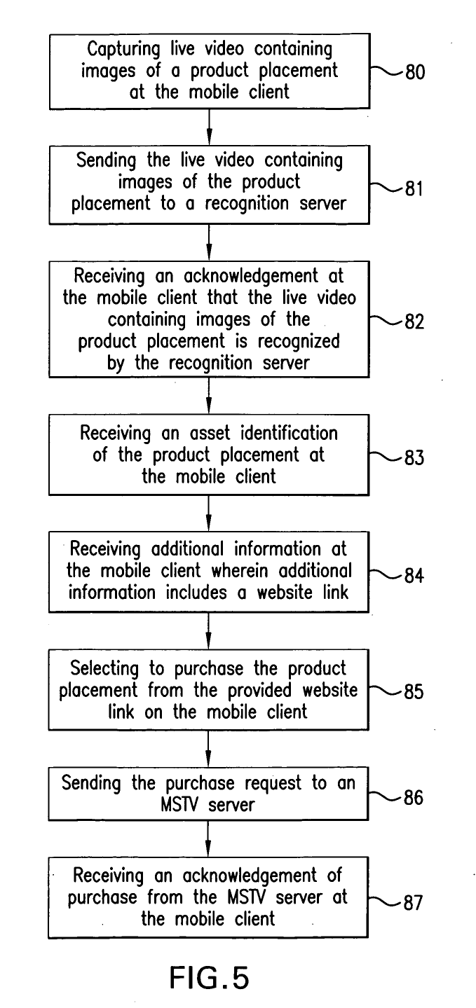

FIG. 5 depicts the method of a preferred embodiment for obtaining more information related to a product placement at a mobile client and transmitting a bookmark to a bookmark server from the mobile client. An operation for capturing live video containing images of a product placement at a mobile client 80 is performed. The method further involves an operation for sending the live video containing images of the product placement to a recognition server 81 (e.g. MER server). In the preferred embodiment, the sending the live video containing images of the product placement to the recognition server is done by pressing a button on the mobile client. Then, an operation is performed for receiving an acknowledgement at the mobile client device that the live video containing images of the product placement is recognized by the recognition server 82. The process further involves an operation for receiving an asset identification of the product placement at the mobile client 83.

The process optionally may further include an operation for receiving additional information at the mobile client wherein additional information includes a website link 84. The process may further include an operation for selecting to purchase the product placement from the provided website link on the mobile client 85. An operation for sending the purchase request from the mobile client to the appropriate server (MSTV) server 86 may also be performed. Finally, an operation for receiving an acknowledgement of purchase from the MSTV server at the mobile client 87 can be performed.

Optionally, an operation for inputting a message at the mobile client related to a bookmark associated with a product placement is performed. Then, an operation for sending the bookmark from the mobile client to the bookmark server with the message is performed.

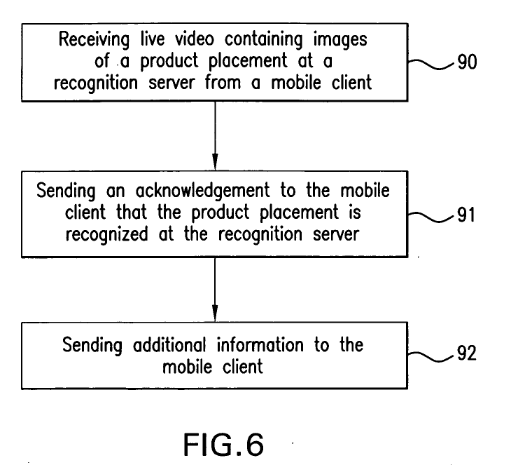

FIG. 6 depicts the method of a preferred embodiment for providing information related to a product placement from a recognition server to a mobile client.

An operation for receiving live video of images of a product placement at a recognition server (MER server) sent from a mobile client 90 is performed. Then, an operation for sending an acknowledgement to the mobile client that the product placement is recognized at the recognition server 91 is performed. Next, an operation for sending additional information to the mobile client 92 is performed. This additional information may include an asset identification message, a video (preview) or website links related to the identified products.

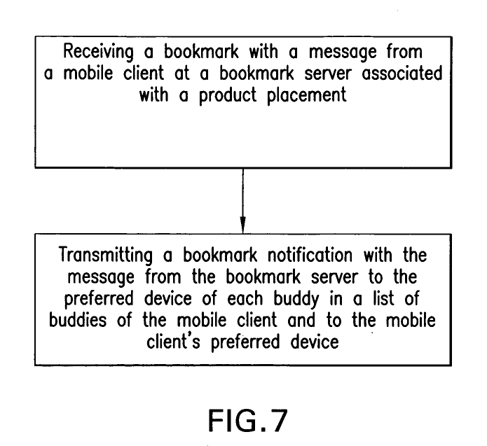

FIG. 7 depicts the method of a preferred embodiment for providing more information related to a product placement from the bookmark server to a list of buddies associated with a mobile client or to a mobile client's preferred device.

An operation for receiving a bookmark with a message from a mobile client at the bookmark server associated with a product placement 100 is performed. Then, an operation for transmitting a bookmark notification with the message from the bookmark server to the preferred device of each buddy in a list of buddies of the mobile client and to the mobile client's preferred device 101 can also be performed.

If a buddy of a mobile client or a mobile client lists television as his preferred device for receiving bookmark notifications, he will receive a bookmark notification on his designated television. If, however, a mobile client or buddy of a mobile client lists his cellular phone as his preferred device, he will receive, for example, a SMS message on his designated cellular phone.

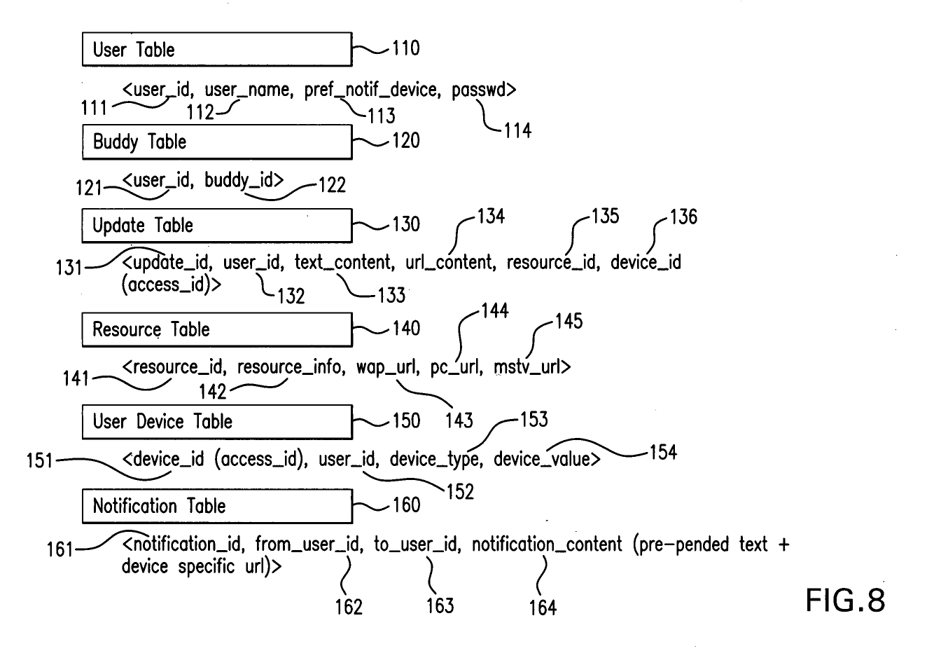

FIG. 8 depicts the database design of the bookmark server of a preferred embodiment of the invention. The bookmark server contains a relational database with six tables in this preferred embodiment. These tables include a user table 110, a buddy table 120, an update table 130, a resource table 140, a user device table 150 and a notification table 160.

The user table 110 contains a user identifier (user_id) 111 that is generated by the database. The user table 110 also contains a user name (user_name) 112 provided by the user at registration time and used for login. The user table 110 also includes a preferred notification device identifier (pref_notif_device) 113 that allows the bookmark server to provide the bookmark notification to the user's preferred notification device. In addition, the user table 110 contains a password (passwd) 114 used as a login password for the user. The user name 112 is unique in this preferred embodiment. However, a real name attribute can be added if needed.

The buddy table 120 contains a user identifier (user_id) 121 which identifies a specific user. The buddy table 120 also includes a buddy identifier (buddy_id) 122 which identifies buddies of the specific user.

The update table 130 contains an update identifier (update_id) 131 that is generated by the database from the device ID, a user identifier (user_id) 132 that identifies the sender of the update, a text content excerpt (text_content) 133 that is pre-pended text by the user (e.g. text saying, “check this out.”), a URL (url_content) 134 giving the web address for the individual receiving a message to utilize, a resource identifier (resource_id) 135 that identifies the resource pointed to (e.g. a number identifying the name of a movie) and a device identifier (device_id) 136 that is used to ascertain the type of device sending the message.

The resource table 140 contains a resource identifier (resource_id) 141 generated by the database, a resource information excerpt (resource_info) 142 that gives basic information on the resource pointed to (e.g. the name of a movie), a WAP URL (wap_url) 143, a PC URL (pc_url) 144 and a MSTV URL (mstv_url) 145 that provide web addresses for users of a mobile phone, computer and video on demand. In this preferred embodiment, the resource information excerpt 142 is unique.

The user device table 150 contains a device identifier (device_id (access_id)) 151 that is populated in the database during initialization, a user identifier (user_id) 152 that identifies the owner of the device, a device type excerpt (device_type) 153 that identifies the type of device (e.g. mobile phone, computer, television) and a device value (device_value) 154 that provides a unique communication identifier for a device. In the preferred embodiment, a given user can have more than one device but each device can only belong to (be owned by) one user. In addition, in the preferred embodiment, each user only has one preferred notification device.

The notification table 160 contains a notification identifier (notification_id) 161 generated by the database, a from user identifier (from_user_id) 162 to identify the individual/user sending the notification, a to user identifier (to_user_id) 163 that identifies the user to whom the notification is sent and a notification content excerpt (notification_content) 164 that includes the actual string sent including the pre-pended text and URL. In the preferred embodiment, each notification is recorded separately in the notification table 160. This notification table 160 can be used for historical data and debugging purposes.

It is contemplated that the method described herein can be implemented as software, including a computer-readable medium having program instructions executing on a computer, hardware, firmware, or a combination thereof. The method described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or taps, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A mobile device for use with a product placement and a recognition server comprising:
(a) a memory containing a set of instructions that permit the mobile device to send a video stream of the product placement to the recognition server and receive an acknowledgement at the mobile device that at least one image in the video stream is recognized by the recognition server; and
(b) a processor connected to the memory for executing the set of instructions.

2. The device of claim 1 wherein the set of instructions further permit the mobile device to receive an asset identification of the product placement.

3. The device of claim 1 wherein the set of instructions further permit the mobile device to receive a website link related to the product placement.

4. The device of claim 3 wherein the set of instructions further permit the mobile device to send a purchase request for at least one of a good and service associated with the product placement from the provided website link on the mobile client.

5. The device of claim 1 wherein the set of instructions further permit the mobile device to send a purchase request from the mobile client to an appropriate server.

6. The device of claim 5 wherein the set of instructions further permit the mobile device to receive an acknowledgement of purchase from the appropriate server.

7. The device of claim 1 wherein the set of instructions further permit a message to be input at the mobile device related to a bookmark associated with the product placement.

8. The device of claim 7 wherein the set of instructions further permit the mobile device to send the bookmark with the message from the mobile device to a bookmark server.

9. A method for obtaining more information related to a product placement at a mobile client comprising the steps of:
(a) capturing a video stream containing images of a product placement on a mobile client; and
(b) sending the video stream containing the images of the product placement to a recognition server.

10. The method of claim 9 further comprising the step of:
receiving an acknowledgement at the mobile client that at least one image in the video stream of the product placement is recognized by the recognition server.

11. The method of claim 9 further comprising the step of:
receiving an asset identification of the product placement at the mobile client.

12. The method of claim 9 further comprising the step of:
receiving a website link associated with the product placement at the mobile client.

13. The method of claim 12 further comprising the step of:
selecting to purchase a good or service associated with the product placement from the provided website link on the mobile client.

14. The method of claim 9 further comprising the step of:
sending a purchase request from the mobile client to an appropriate server.

15. The method of claim 14 further comprising the step of:
receiving an acknowledgement of purchase from the appropriate server at the mobile client.

16. The method of claim 9 further comprising the step of:
inputting a message at the mobile client related to a bookmark associated with the product placement.

17. The method of claim 16 further comprising the step of:
sending the bookmark from the mobile client to a bookmark server with the message.

18. The method of claim 9 further comprising the step of transmitting a bookmark associated with the product placement to a bookmark server from the mobile client.

19. The method of claim 9 wherein the step of sending the video stream containing the images of the product placement to the recognition server involves pressing a button on the mobile client.

20. A method for providing information related to a product placement from a recognition server to a mobile client comprising the steps of:
(a) receiving a video stream containing images of the product placement at the recognition server from the mobile client; and
(b) sending additional information to the mobile client from the recognition server.

21. The method of claim 20 wherein the step of sending additional information includes at least one of sending an asset identification message that identifies the product placement and sending an acknowledgment that the product placement is recognized at the recognition server.

22. The method of claim 20 wherein the step of sending additional information includes sending a video preview related to the product placement.

23. The method of claim 20 wherein the step of sending additional information includes sending a website link related to the product placement.

24. A method for providing information related to a product placement from a bookmark server comprising the steps of:
(a) receiving a bookmark from a mobile client at the bookmark server associated with the product placement; and
(b) transmitting a bookmark notification from the bookmark server to a preferred device of each buddy in a list of buddies of the mobile client.

25. The method of claim 24 further comprising the steps of:
receiving a message associated with the bookmark from the mobile client at the bookmark server and transmitting the bookmark notification with the message from the bookmark server to the preferred device of each buddy.

26. The method of claim 25 further comprising the step of:
transmitting the bookmark notification with the message from the bookmark server to a preferred device of the mobile client.

27. A bookmark server comprising:
a notification data repository having a user table, a buddy table, an update table, a resource table, a user device table and a notification table.

28. The bookmark server of claim 27 wherein the user table includes a user identifier, a user name, a preferred notification device identifier and a password.

29. The bookmark server of claim 27 wherein the buddy table includes a user identifier and a buddy identifier.

30. The bookmark server of claim 27 wherein the update table includes an update identifier, a user identifier, a text content excerpt, a URL, a resource identifier and a device identifier.

31. The bookmark server of claim 27 wherein the resource table includes a resource identifier, a resource information excerpt, a WAP URL, a PC URL and a MSTV URL.

32. The bookmark server of claim 27 wherein the user device table includes a device identifier, a user identifier, a device type excerpt and a device value.

33. The bookmark server of claim 27 wherein the notification table includes a notification identifier, a from user identifier, a to user identifier and a notification content excerpt.
